(19) United States
(12) Patent Application Publication
(10) Pub. No.: US 2002/0048363 A1
(43) Pub. Date: Apr. 25, 2002

(54) Portable electronic apparatus having a reinforced housing

(76) Inventors: Gerd Jakob Ernst Scheller, Thalwill (CH); Stefan Koch, Zurich (CH); Daniel Mueller, Birmensdorf (CH); Fabrice Rossetti, Horgen (CH)

Correspondence Address: U.S. Philips Corporation, 580 White Plains Road, Tarrytown, NY, 10591, US

(21) Appl. No.: 09/925,343

(22) Filed: Aug. 9, 2001

(30) Foreign Application Priority Data
Aug. 11, 2000 (DE) 10039306.3

(51) Int. Cl. H04M 1/00; H04M 9/00

(52) U.S. Cl. 379/433.11; 379/440

(57) ABSTRACT

The invention relates to an electronic apparatus (1) whose housing (2) is provided with a housing part that is constructed as a lever element (3) and whose hardness exceeds the hardness of crown caps so as to avoid damaging of the edges of a mobile telephone (1). To this end, the battery compartment of the mobile telephone is covered by means of an angled metal plate.

The invention relates to a portable electronic apparatus which is provided with a housing. The invention also relates to a mobile telephone which is provided with a housing.

The use of electronic apparatus is very wide spread. Their use will become even more wide spread in future. Portable electronic apparatus are conceived notably as a Personal Digital Assistant, as a mobile telephone or as a portable music playback apparatus. All such portable electronic apparatus have in common that they have a long standby time, a low weight and adequate ruggedness to provide appropriate functionality, carrying comfort and resistance against environmental influences in daily use, for example, shocks, pressures, dropping, humidity and exposure to heat. The trend towards constructing such portable electronic apparatus to be multifunctional cannot be stopped. Functions of individual portable apparatus are thus merged so that, for example a mobile telephone takes over functions of a Personal Digital Assistant for example a notebook and calendar functions.

U.S. Pat. No. 5,531,365 discloses a mobile telephone with a belt clip. The clip serves to attach the mobile telephone to the clothing worn. The clip is constructed as a multifunctional tool and includes a screwdriver, a knife, a bottle opener, a corkscrew, etc. The multifunctional tool is protected by a cover so that no damage can be incurred when the portable electronic apparatus is attached to the clothing.

Abuse of such apparatus also increases as the use of such electronic apparatus becomes more wide spread. The electronic apparatus is even abused as a striking tool or as a lever. A particularly large force is then exerted on the sides of the housing of such electronic apparatus, so that the edges are broken away and the components situated inside are liable to be damaged. From the condition that portable electronic apparatus must have a suitable low weight so as to minimize the weight experienced during use it follows that the housing of such electronic apparatus is made of synthetic materials. Moreover, in the case of, for example a mobile telephone, a housing of a synthetic material is advantageous in a sense that the synthetic material has no effect on the transmission and receiving properties of the mobile telephone.

Therefore, it is an object of the invention to propose a portable electronic apparatus which is provided with a housing which offers adequate ruggedness to withstand abuse.

This object is achieved by means of a portable electronic apparatus whose housing includes a part that is constructed as a lever element and whose hardness exceeds the hardness of metal closures.

The electronic apparatus is enclosed by a housing that consists mainly of a synthetic material. The battery packs form an important part of such electronic apparatus. Such battery packs are usually situated at the rear of the housing and are protected by means of a lid of a synthetic material. Constructing the lid from a synthetic material has a drawback in a sense that exactly the lower edge of the lid is used as a lever element for lifting off objects, for example bottle caps. This edge is usually provided with a radius which impedes its application as a lever element. The battery pack represents a very vulnerable and expensive component of the electronic apparatus and damaging it makes the apparatus unusable or necessitates a new battery pack while the user is exposed to a substantial risk of injury at the same time.

In accordance with the invention the lid of the battery pack is used as a lever element and is made of a material whose hardness exceeds that of, for example a crown cap. The lever element is preferably constructed in such a manner that a material having a hardness that is lower than that of the lever element can be bent under the influence of a leverage effect. Crown caps are usually made of a metal alloy of a comparatively low hardness. The lever element has, for example a hardness of 5 on the Mohs' scale of hardness and the bottle caps are significantly softer due to constituents such as aluminum or tin.

A hardness of the lever element that suffices to bend a crown cap is achieved by means of steel alloyed with chromium or nickel. At the same time such a material must also be capable of withstanding environmental influences and the effects of daily use. Therefore, it should also be corrosion-resistant.

The lever element is connected to the housing of the portable electronic apparatus in such a manner that it is suitable for opening metal closures. The lever element may be made of a metal or a ceramic material; a combination of the two materials is also possible. In order to use this leverage element for the opening of metal closures, it is advantageous to form a plate of said materials so that it has the appropriate angled shape. This also offers the advantage that a lid of greater hardness for the battery pack offers significantly better protection against mechanical or environmental influences than a lid made of a synthetic material.

Electronic apparatus are usually provided, for example at the lower side of the battery pack, with a connection unit for connecting the battery pack or the electronic apparatus to a charging apparatus or an external apparatus. When the electronic apparatus is abused, for example for the opening of bottles, notably such connection units also suffer or are destroyed. Therefore, the lever element is particularly advantageously constructed as an angled metal plate in such a manner that the connection unit is covered.

Various embodiments of such a metal plate are feasible. On the one hand, the lid of the battery compartment can be constructed as a flush metal plate. The edge of this lid should then be given the appropriate angled shape so as to achieve a suitable leverage effect. The anchoring of the lid plate of the battery compartment should then be proportionally stronger.

It is an advantage of the embodiment of the housing in accordance with the invention, being provided with an angled metal plate that constitutes only a part of the housing, that, because of the small dimensions of the metal plate, the weight of the electronic apparatus is not noticeably increased whereas the service life of the housing, of the battery pack and of the connection unit is significantly prolonged nevertheless.

In a particularly attractive embodiment of the invention the part of the housing that is constructed as a lever element is provided only partly with metal elements, so that a further reduction of weight is achieved while maintaining the ruggedness. For example, only the very edge of the battery pack lid could then be made of a hard metal.

The object is also achieved by means of a mobile telephone which is provided with a housing at the rear of which there is provided a lever element which offers protection against shocks, pressure and other environmental influences and also protects the accumulator.

An embodiment will be described in detail hereinafter with reference to the figures.

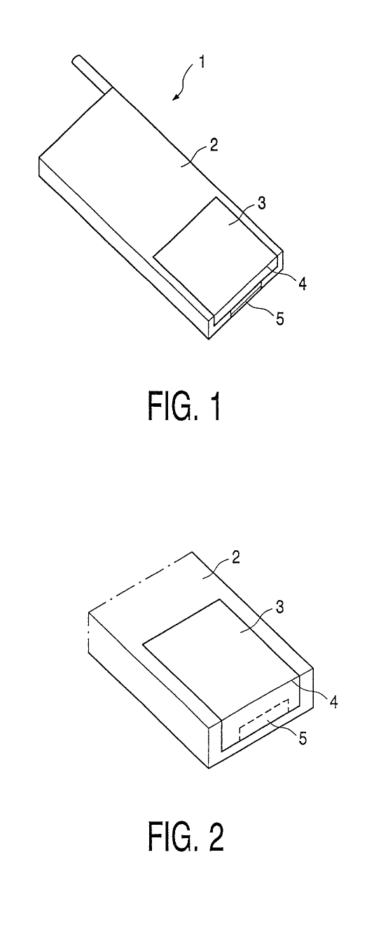

FIG. 1 shows the rear of a mobile telephone 1 with a lever element, and

FIG. 2 shows a further embodiment of a lever element.

The mobile telephone is enclosed by a housing 2. The housing 2 is made of a synthetic material. The lid 3 for the battery compartment also forms part of the housing. The battery pack is protected by the lid 3 which is constructed as a lever element in accordance with the invention. The construction of the lever element 3 is such that the edge 4 has an angle enabling the opening of bottle caps by leverage. The reference numeral 5 denotes the connection unit for the connection of a charging apparatus or a hands-free device for mobile telephones.

FIG. 2 shows that, because of its angled shape, the lever element 3 covers the connection unit 5. In order to charge the battery of the mobile telephone or the portable electronic apparatus, the lever element should then be separated from the housing of the mobile telephone. This is advantageous notably when the mobile telephone is subject to extreme mechanical loads and environmental influences during use.

A lever element having an angled shape can also be used to protect the edges of the housings of notebooks, PCMCA cards or dictation apparatus.

1. A portable electronic apparatus (1) whose housing (2) is provided with a housing part that is constructed as a lever element (3), which is arranged in a wall of the housing and is arranged to cover at least partly a battery pack.

2. A portable electronic apparatus as claimed in claim 1, characterized in that the lever element is arranged to bend a material of lower hardness by way of a leverage effect.

3. A portable electronic apparatus as claimed in claim 1, characterized in that the lever element is arranged to open metal closures and is connected to the housing.

4. A portable electronic apparatus as claimed in claim 1, characterized in that the lever element is made of metal and/or ceramic.

5. A portable electronic apparatus as claimed in claim 1, characterized in that the lever element is constructed as an angled metal plate so as to cover a battery pack.

6. A mobile telephone (1) which includes a housing (2), whose housing (2) is provided with a housing part that is constructed as a lever element (3), which is emedded in a wall of the housing and is arranged to cover at least partly a battery pack.

7. A mobile telephone housing, at the rear of which there is provided a lever element (3) which offers protection against shocks and pressure and also protects the accumulator, whereby the housing (2) is provided with a housing part that is constructed as a lever element (3), which is arranged in a wall of the housing and is arranged to cover at least partly a battery pack.
